(19) United States
(12) Patent Application Publication
(10) Pub. No.: US 2004/0041700 A1
(43) Pub. Date: Mar. 4, 2004

(54) Speed indicating means

(76) Inventor: Yi Mei Hsieh, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/229,090

(22) Filed: Aug. 28, 2002

(51) Int. Cl. B60Q 1/54

(52) U.S. Cl. 340/466

(57) ABSTRACT

A speed indicating means includes an induction unit for detecting a speed to generate a speed signal, which is sent to an operation & comparison control unit for operation and comparison, so that a control signal is output to an indicating unit. The indicating unit includes differently colored luminescent sheets attached to an outer end of an exhaust pipe to represent different ranges of speed. A corresponding one of the luminescent sheets is caused by the control signal to produce color light to warn a car following behind the current speed of the preceding car. Alternatively, the luminescent sheets may be controlled via a switch to produce color light as a decoration for the car.

### FIELD OF THE INVENTION

The present invention relates to a speed indicating means, and more particularly to a speed indicating means that includes luminescent sheets sequentially attached to an exhaust pipe to produce different color lights, each of which represents a specific range of speed.

### BACKGROUND OF THE INVENTION

It is very important to control the speed of a moving car. A driver also has to correctly judge the speed of a preceding car to make proper response during passing, parking, or changing down. The driver usually judges the speed of the preceding car by experiences, but the experiences are not always reliable. A wrong judgment based on experiences would result in the risk of an accident. However, all the currently commercially available cars include brake lamps but not any means for showing the current speed to warn a car following behind.

### SUMMARY OF THE INVENTION

It is a primary object of the present invention to provide a speed indicating means that includes an induction unit for detecting a speed to generate a speed signal, which is sent to an operation & comparison control unit for operation and comparison to determine a range of speed into which the detected speed falls, so that a control signal is output to an indicating unit. The indicating unit includes differently colored luminescent sheets attached to an outer end of an exhaust pipe to each represent a specific range of speed. One of the luminescent sheets is caused by the control signal to produce color light to inform a car following behind the current speed of the preceding car.

Another object of the present invention is to provide a speed indicating means that uses differently colored luminescent sheets to indicate different ranges of speed and is therefore particularly suitable for use in the nighttime.

A further object of the present invention is to provide a colored decoration mounted on an exhaust pipe of a car. The decoration includes a plurality of luminescent sheets mounted around the exhaust pipe and controlled via a switch to produce color light.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing the structure of a speed indicating means according to an embodiment of the present invention;

FIG. 2 is a flowchart showing the operation of the speed indicating means of FIG. 1;

FIG. 3 is an exploded perspective view of the speed indicating means of the present invention;

FIG. 4 is an assembled perspective view of FIG. 3; and

FIG. 5 shows the speed indicating means of the present invention is mounted on an exhaust pipe of a car.

### DETAILED DESCRIPTION OF THE PREFERRED EMBODIMENTS

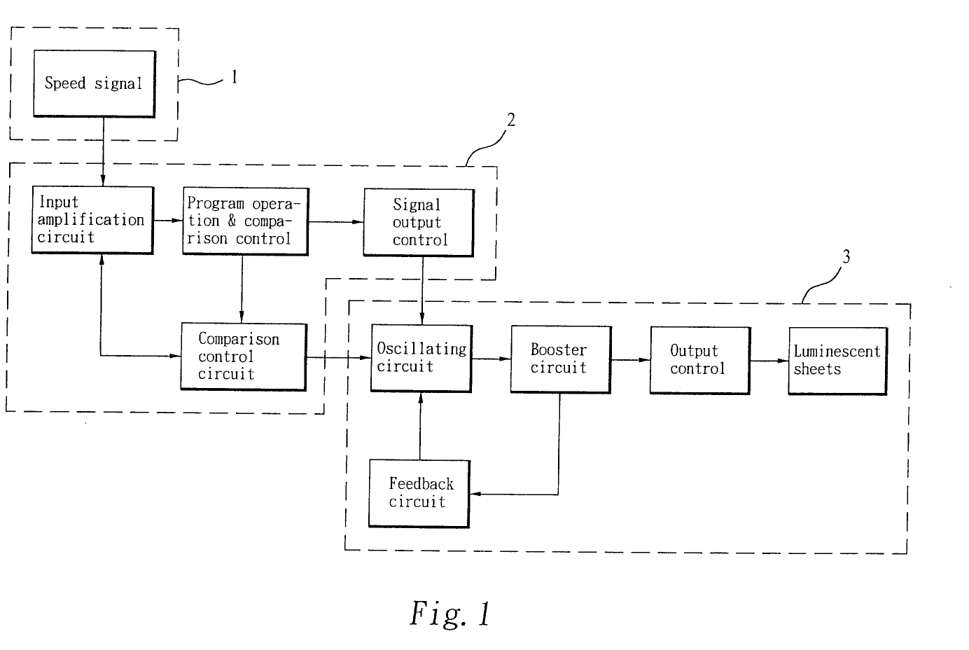

Please refer to FIG. 1 that is a block diagram showing the structure of a speed indicating means according to an embodiment of the present invention. As shown, the speed indicating means mainly includes an induction unit 1 capable of detecting a car speed. The induction unit 1 may be mounted on a car engine to detect the speed or connected to a speed meter to obtain the speed. A numerical value V of the detected or obtained speed is input as a speed signal to an operation & comparison control unit 2, which includes an input amplification circuit, a program operation control, a comparison control circuit, and a signal output control to function like a microcomputer.

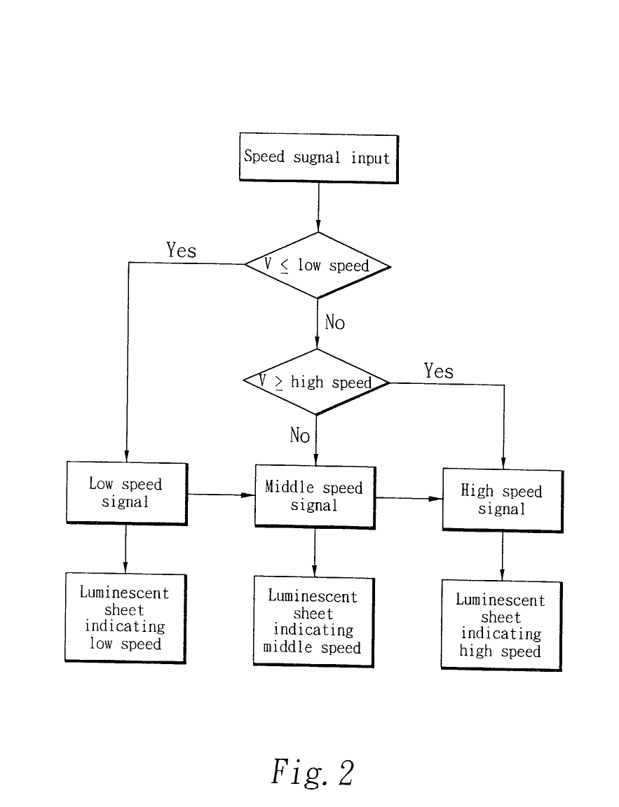

FIG. 2 is a flowchart showing the operation of the operation & comparison control unit 2. After the speed signal input representing the obtained numerical value V is amplified via the amplification circuit, the value V is then compared in the operation & comparison control unit 2 to determine whether the value V falls in a range of low, middle, or high speed. The signal output control then outputs a low-speed, a middle-speed, or a high-speed control signal to an indicating unit 3 (see FIG. 1).

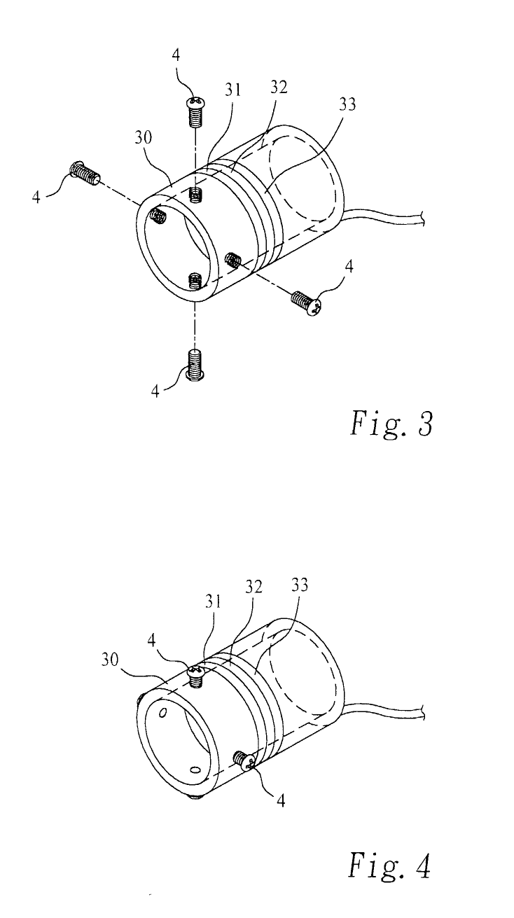

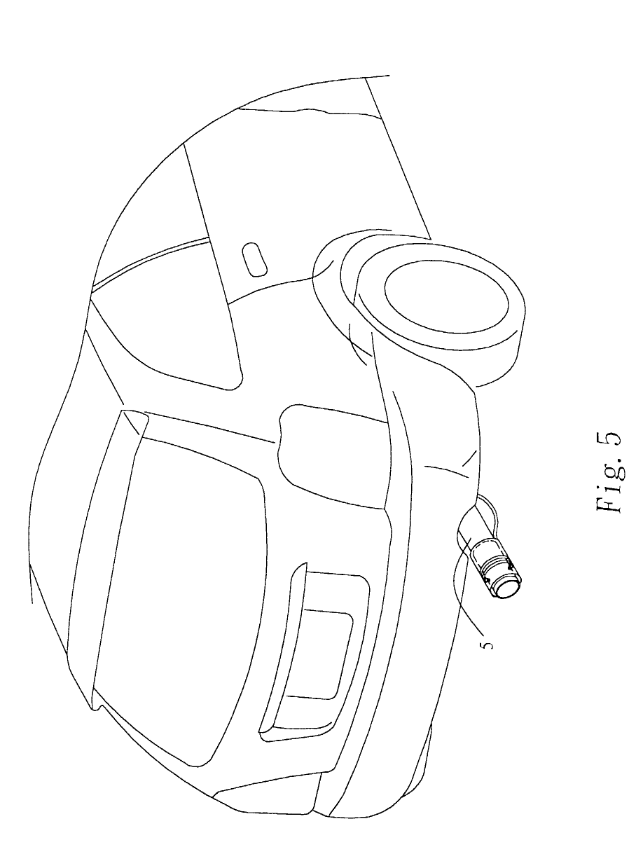

Please refer to FIG. 1 again. The indicating unit 3 includes a driving circuit consisting of an oscillating circuit, a booster circuit, a feedback circuit, and an output control, and a plurality of differently colored luminescent sheets. Please now refer to FIGS. 3, 4, and 5. Luminescent sheets 31, 32, and 33 are attached to a sleeve 30 that is adapted to mount on an exhaust pipe around an outer end thereof by means of screws 4, as shown in FIG. 5. When the driving circuit of the indicating unit 3 receives the low-speed, the middle-speed, or the high-speed control signal sent by the operation & comparison control unit 2, the oscillating circuit causes the booster circuit to output a voltage for one of the luminescent sheets corresponding to different ranges of speed to produce light showing a specific color corresponding to the particular speed signal.

By mounting the speed indicating means of the present invention on the exhaust pipe of a car, other cars behind the car may easily tell the range of speed of the preceding car via the color of light produced by one of the luminescent sheets 31, 32, and 33 that separately correspond to a specific speed signal. Therefore, accidents of car impact due to incorrect judgment of the speed of a preceding car can be largely reduced.

Since the speed indicating means of the present invention utilizes luminescent sheets producing different color light to indicate different speeds, it is particularly useful in the nighttime.

In the illustrated embodiment, the speed is divided into three ranges, namely, low, middle, and high speeds. However, it is understood the speed may also be divided into only two ranges, namely, low and high speeds, or into four or more ranges. This can be done through adjusting a control program of the present invention to set one or multiple ranges of numerical values for the speed. All these changes can be carried out without departing from the scope and the spirit of the invention as defined by the appended claims.

The luminescent sheets of present invention mounted at a rear part of the car may be otherwise directly controlled with a switch circuit instead of the speed. A user needs only to turn on the switch to make the indicating unit 3 for the luminescent sheets to produce color light and serve as a decoration of the car.

What is claimed is:

1. A speed indicating means, comprising:
an induction unit adapted to connect to an engine or a speed meter of a car to detect a rotating speed of the engine or a speed of the car, and to output a signal representing the detected speed;
an operation & comparison control unit functioning like a microcomputer to receive the speed signal output by said induction unit, and to calculate and compare the received speed signal with many preset ranges of speed, and to determine one of said preset ranges of speed in to which said detected speed falls, so as to output a corresponding control signal; and
an indicating unit including a plurality of differently colored luminescent sheets sequentially attached to an exhaust pipe around an outer end thereof, and a driving circuit; said driving circuit receiving said control signal output by said operation & comparison control unit to control a corresponding one of said luminescent sheets to produce color light that indicates a specific range of speed to warn a car following behind.

2. The speed indicating means as claimed in claim 1, wherein said ranges of speed preset by said operation & comparison control unit include low, middle, and high speeds; and said luminescent sheets of said indicating unit are correspondingly divided into three different colors.

3. The speed indicating means as claimed in claim 1, wherein said operation & comparison control unit includes an input amplification circuit, a program operation control, a signal output control, and a comparison control circuit.

4. The speed indicating means as claimed in claim 1, wherein said driving circuit of said indicating unit includes an oscillating circuit, a booster circuit, a feedback circuit, and an output control.

5. A decoration for exhaust pipe, comprising:
a switch for controlling on and off of a circuit; and
an indicating unit including a plurality of differently colored luminescent sheets sequentially attached to said exhaust pipe around an outer end thereof, and a driving circuit;
whereby when said switch is turned on, said driving circuit is energized to cause said luminescent sheets to produce color light.
